(19) United States
(12) Patent Application Publication
(10) Pub. No.: US 2010/0333024 A1
(43) Pub. Date: Dec. 30, 2010

(54) Dynamic Database Filter Method and System

(75) Inventor: Henry CHAN, Richmond (CA)

Correspondence Address: STEPHEN R. BURRI, MILLER THOMSON LLP, 1000 - 840 HOWE STREET, VANCOUVER, BC, V6Z 2M1, CA

(73) Assignee: INK RESEARCH CORP., Vancouver (CA)

(21) Appl. No.: 12/822,958

(22) Filed: Jun. 24, 2010

Related U.S. Application Data
(60) Provisional application No. 61/220,180, filed on Jun. 24, 2009.

(51) Int. Cl. G06F 3/048; G06F 17/30

(52) U.S. Cl. 715/816; 707/771; 707/E17.014

(57) ABSTRACT

A computer-implemented method and a computer readable memory for providing a user with database search results in response to search categories and filter criteria selected by the user, comprising the steps of: selection by the user of a search category to display; selection by the user of one or more filter criteria from the list of displayed filter criteria within the displayed search category; repetition of steps a) and b) until all desired filter criteria have been selected; search of the database by applying the selected filter criteria to produce a database search result; and selection by the user of a display mode for the database search result. According to another embodiment of the present invention, there is provided a computer program for instructing a computer to perform the methods described herein.

### FIELD OF THE INVENTION

The present invention relates to online database systems, and particularly relates to a filtering method and apparatus for database searching.

### BACKGROUND OF THE INVENTION

With traditional online searching and filtering of large complex sets of structured data, that is, data where most of the fields are one or more entries from a known set of all possible entries, the display of all possible criteria may be overwhelming and may require a large screen area to permit display of all choices available to the user. Further, drop-down lists may only allow selection of one menu item at a time, severely limiting the effectiveness of the search method.

Alternatively, check boxes may require a large area of the limited available screen space, and if there are many available choices, it may become difficult for users to quickly sum up their selection visually. It also may have the effect of overwhelming users with too many choices at once.

Another alternative is use of a list box, but screen space limitations remain an issue and if allowance is only made for display of a small subset at a time, it becomes even more difficult for the user to scroll through the list without the ability to see all the choices and selected criteria simultaneously.

For these reasons, existing data search and filter systems may be cumbersome to use when the selectable criteria set is large and complex. Either the selection criteria must be displayed on one page while results are displayed on another, or the criteria must be displayed on the top section of a long scrollable page while the results may be at the bottom. Either situation is undesirable.

Firstly, users may become overwhelmed when presented with all the selectable criteria on a single page or screen. This may tend to scare away users who are seeking a quick or simple search solution. Secondly, it is beyond the ability of an average user to quickly summarize more than a few criteria simultaneously when all the criteria are laid out on one page or screen or more. Thirdly, a user would need to remember their search or filter criteria when the results set are returned on a separate page or far below the selection portion of the page. Finally, extra steps may be required if a user wants to quickly fine tune or completely change his or her search or filter criteria because of the need to scroll to a different section of the page or even to go back to the search/filter page or screen.

The dynamic database filter method and system addresses these difficulties with the prior art.

### SUMMARY OF THE INVENTION

According to one embodiment of the present invention, there is provided a computer-implemented method for providing a user with database search results in response to search categories and filter criteria selected by the user, comprising the steps of: a) selection by the user of a search category to display; b) selection by the user of one or more filter criteria from the list of displayed filter criteria within the displayed search category; c) repetition of steps a) and b) until all desired filter criteria have been selected; d) search of the database by applying the selected filter criteria to produce a database search result; and e) selection by the user of a display mode for the database search result.

The method may further comprise the additional step after step e) of: f) repetition of steps a) through e) until a desired search result is displayed in a desired display mode.

The user may identify the filter criteria within a search category prior to selection of that search category by moving a cursor or similar computer selection tool over a computer icon representing that search category.

The selection of a filter criterion may effect a change in an indicator means to allow visual distinction between selected filter criteria and unselected filter criteria prior to application of the criteria to a database search. Similarly, the application of a filter criterion to a database search may effect a change in an indicator means to allow visual distinction between unapplied filter criteria and applied filter criteria. The indicator means may comprise a change in colours, shades, or background patterns. In an alternate embodiment, the indicator means may comprise a change in text fonts or text styles.

According to another embodiment of the present invention, there is provided a computer program for instructing a computer to perform the methods described herein.

Yet a further embodiment comprises a computer readable memory having recorded thereon statements and instructions for execution by a computer to carry out the methods described herein.

A further embodiment of the present invention comprises a networked computer system comprising a server, wherein the server is configured to define a plurality of graphical user interfaces on an access device associated with a user, the interfaces comprising: a plurality of user-selectable parameters, including at least one filter criterion selected from a plurality of available filter criteria and at least one result control for controlling display of search results determined for the selected filter criteria.

A user may identify the filter criteria within a search category prior to selection of that search category by moving a cursor or similar computer selection tool over a computer icon representing that search category. Selection of a filter criterion may effect a change in an indicator means to allow visual distinction between unapplied filter criteria and applied filter criteria. The indicator means may comprise a change in colours, shades, or background patterns. Alternatively, the indicator means may comprise a change in text fonts or text styles.

### BRIEF DESCRIPTION OF THE DRAWINGS

A detailed description of the preferred embodiments is provided below by way of example only and with reference to the following drawings, in which:

FIG. 1 shows a screen shot of the initial state of the apparatus of the present invention;

FIG. 2 shows a screen shot of the initial state of the apparatus of the present invention, with the filing date search criteria displayed;

FIG. 3 shows a screen shot of the initial state of the apparatus of the present invention, with the transaction nature search criteria displayed;

FIG. 4 shows a screen shot of the initial state of the apparatus of the present invention, with the insider relationship search criteria displayed;

FIG. 5 shows a screen shot of the initial state of the apparatus of the present invention, with the ownership type search criteria displayed;

FIG. 6 shows a screen shot of the initial state of the apparatus of the present invention, with the exchange search criteria displayed;

FIG. 7 shows a screen shot of the initial state of the apparatus of the present invention, with the capitalization search criteria displayed;

FIG. 8 shows a screen shot of the initial state of the apparatus of the present invention, with the trading range search criteria displayed;

FIG. 9 shows a screen shot of the initial state of the apparatus of the present invention, with the sector search criteria displayed;

FIG. 10 shows a screen shot of the initial search results produced by applying the initial search criteria;

FIG. 11 shows a screen shot of the initial search results and amended transaction nature search criteria;

FIG. 12 shows a screen shot of the secondary search results after application of the amended transaction nature search criteria;

FIG. 13 shows a screen shot of the apparatus of the present invention, with a user predefined saved set of search criteria applied and the corresponding results displayed;

FIG. 14 shows a screen shot of the apparatus of the present invention, displaying transaction nature filter criteria;

FIG. 15 shows a screen shot of the apparatus of the present invention, displaying security type filter criteria;

FIG. 16 shows a screen shot of the apparatus of the present invention, displaying insider relationship filter criteria;

FIG. 17 shows a screen shot of the apparatus of the present invention, displaying ownership type filter criteria;

FIG. 18 shows a screen shot of the apparatus of the present invention, displaying a reset button for reversion to the previous set of filter settings;

FIG. 19 shows a screen shot of the apparatus of the present invention, displaying the search results obtained by applying a set of amended filter criteria;

FIG. 20 shows a screen shot of the apparatus of the present invention, displaying data in graphical form;

FIG. 21 shows a screen shot of the apparatus of the present invention, displaying transaction nature filter criteria prior to amendment;

FIG. 22 shows a screen shot of the apparatus of the present invention, displaying transaction nature filter criteria after amendment;

FIG. 23 shows a screen shot of the apparatus of the present invention, displaying search results prior to application of amended transaction nature filter criteria;

FIG. 24 shows a screen shot of the apparatus of the present invention, displaying equity overview search results after application of amended transaction nature filter criteria;

FIG. 25 shows a screen shot of the apparatus of the present invention, displaying filings search results after application of amended transaction nature filter criteria; and

FIG. 26 shows a screen shot of the apparatus of the present invention, displaying holdings search results after application of amended transaction nature filter criteria.

In the drawings, one embodiment of the invention applying insider trading data is illustrated by way of example. It is to be expressly understood that the description and drawings are only for the purpose of illustration and as an aid to understanding, and are not intended as a definition of the limits of the invention.

### DETAILED DESCRIPTION OF THE INVENTION

The preferred embodiments of the present invention will be described with reference to the drawings, in which like numerals represent like elements throughout the several figures. The preferred operating environment for the present invention comprises a general- purpose computing device in the form of a personal computer linked via the Internet according to known methods to other general purpose computing devices.

There is provided a horizontal, vertical or floating arrangement of graphical user interfaces which allow web-based users to easily navigate through a relatively large and complex set of search/filter criteria and to define a search based on multiple screening categories. Unlike prior art screen layouts where all the search/filter criteria are displayed simultaneously, the display method of the present invention initially hides the detailed criteria list for each filter category to avoid overwhelming users.

To economize the screen space required to display the selected criteria for a search, only a summary of the selected criteria is displayed after being chosen when the selectable criteria are not expanded in a dropped down/pop-up window. To achieve this, an icon system is used to represent the selected criteria with a mouse-over for a description of the particular criteria. Background color is used to indicate whether the displayed criteria have been applied to the filter. Criteria summary that have not been applied to the search results are presented in a more prominent background colors such as red, orange or yellow, or have a patterned fill. Background color of criteria summary that have been applied to the result set are presented in a less prominent, more neutral color such as blue or gray.

A major advantage to the hidden criteria selection is space reduction which allows for the search and/or filter results to be presented below the criteria used with or without multi-tabbed sections, depending on information organization. In addition, with the criteria continually displayed across multiple tabs or pages containing the result set of data and data images, the invention allows users to easily see what criteria the search/filter was based on so that the user can quickly fine tune or completely change the criteria without the extra steps of reloading a search input page. The search/filter criteria can be saved on the back-end server or via cookies to allow for the user's criteria set to be pulled up the next time the user uses the page again. This also facilitates the ability for the user to reset the search and/or filter criteria back to the initial state or to previous criteria sets as desired.

To solve the problems identified above, there is provided a user interface that incorporates all of the necessary selection criteria and informational display functions into a search/filter bar comprising one or a few lines or columns best described as a detachable moveable continuous, dynamic display multi-category interactive filter bar, and designated for the purposes of this specification as the “INK filter bar”.

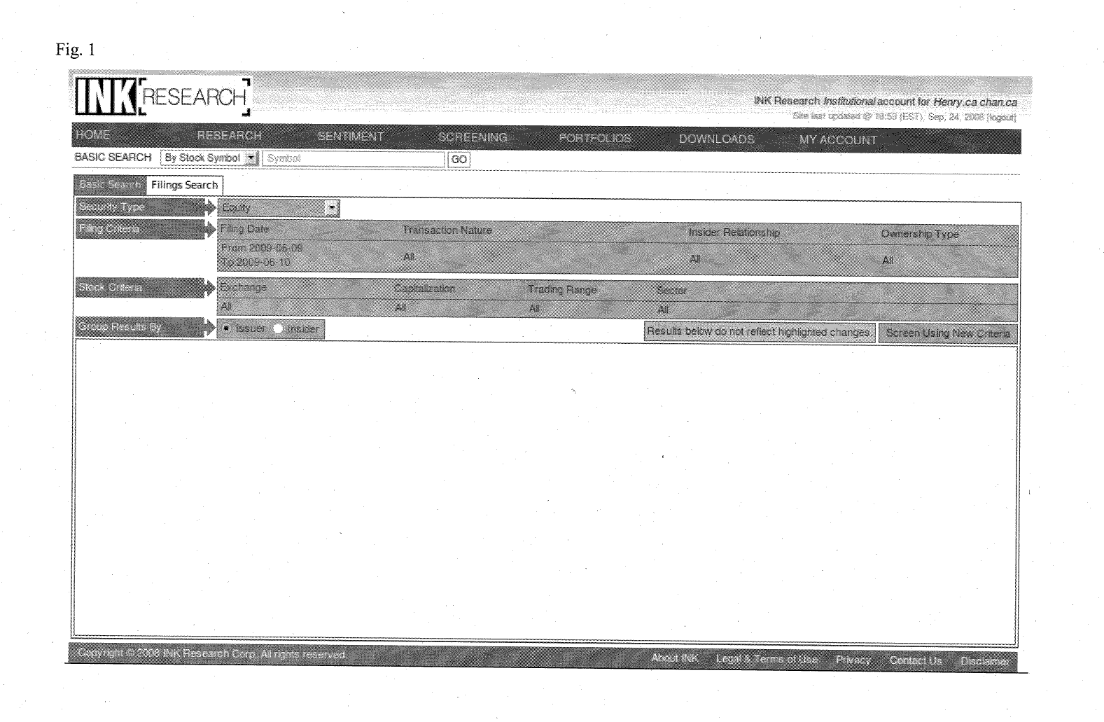

As best seen in FIG. 1, in its initial state, each available search and/or filter criteria category appears in the INK Filter Bar as a separately labeled box with the selected criteria summarized below it. The INK filter bar employs an icon system that utilizes various symbols, icons, letters numbers and sliding bar scales (collectively, the “Icons”) to condense the space requirement. The INK filter bar enables display of information concerning the meaning of Icons by the user moving the mouse over the Icon. The Icons will refer to categories of the searchable data set and may or may not be used in the presentation of data and data images that is produced as a result of applying the search criteria. When all the possible choices are selected, the option “All” may be selected to reduce the screen space requirement. The first time the INK Filter Bar is used, the background color of the criteria summary box areas will be displayed in a prominent color such as red, orange or yellow, or in a patterned fill such as diagonal lines, along with a brief message to warn users that none of the selected criteria have been applied to the search result. As the search criteria have not yet been applied to the data set, no result set is yet displayed below the INK Filter Bar in its initial state.

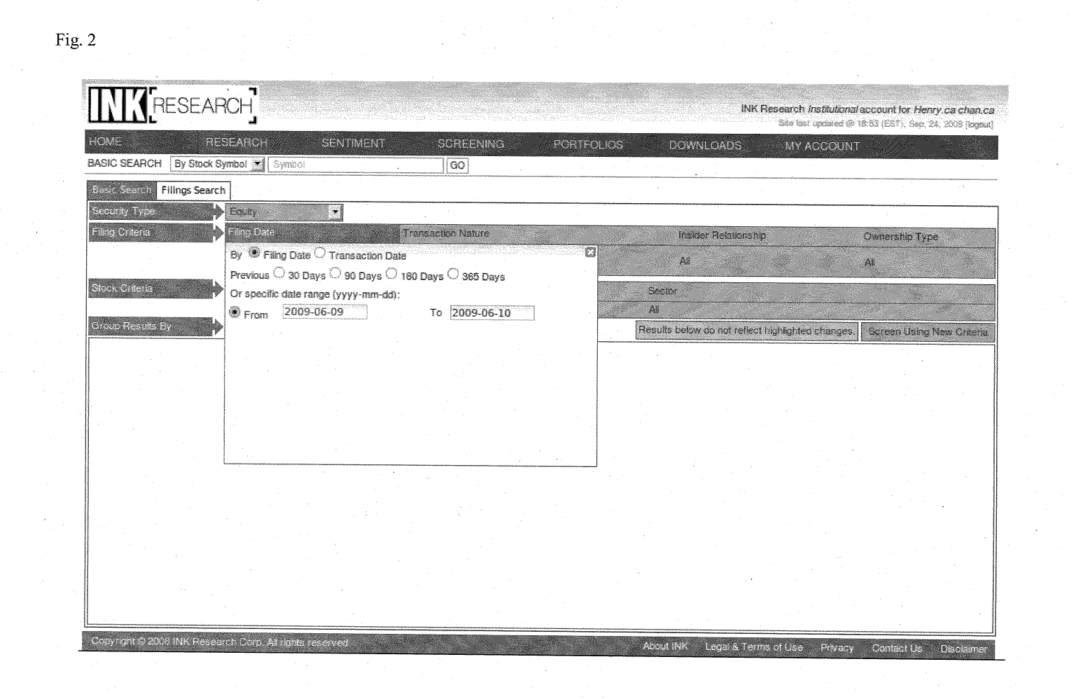

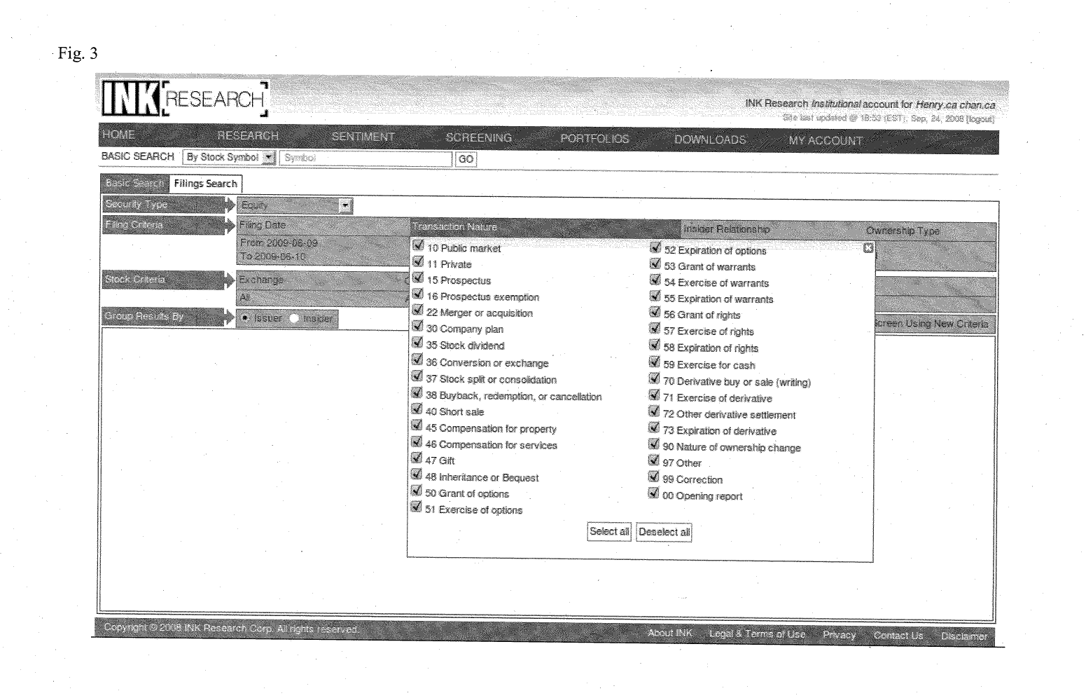

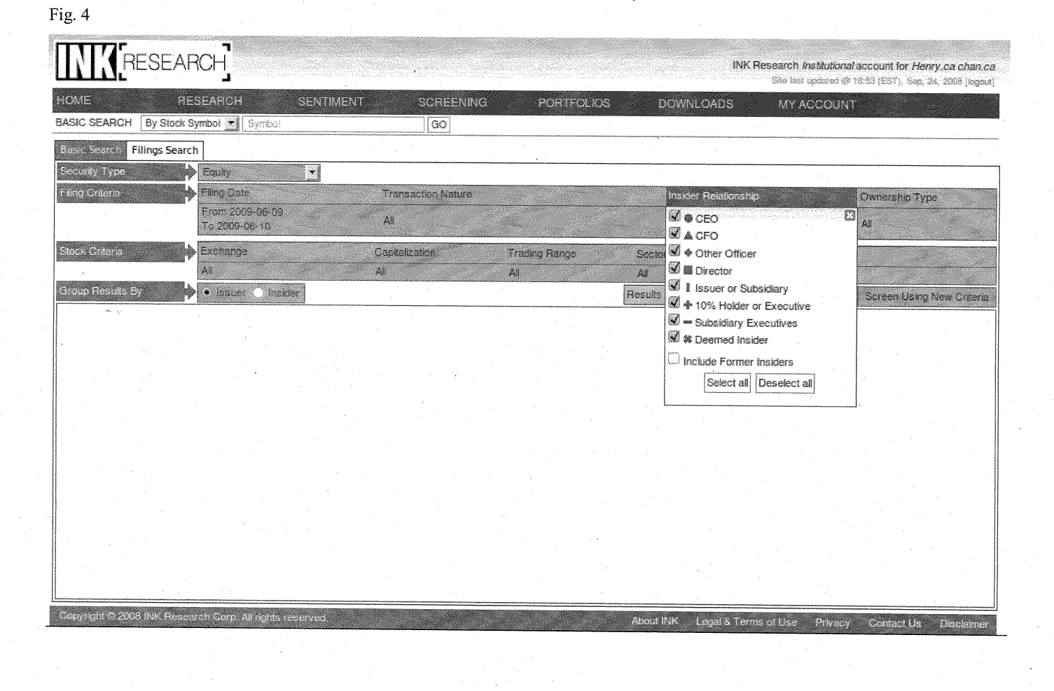

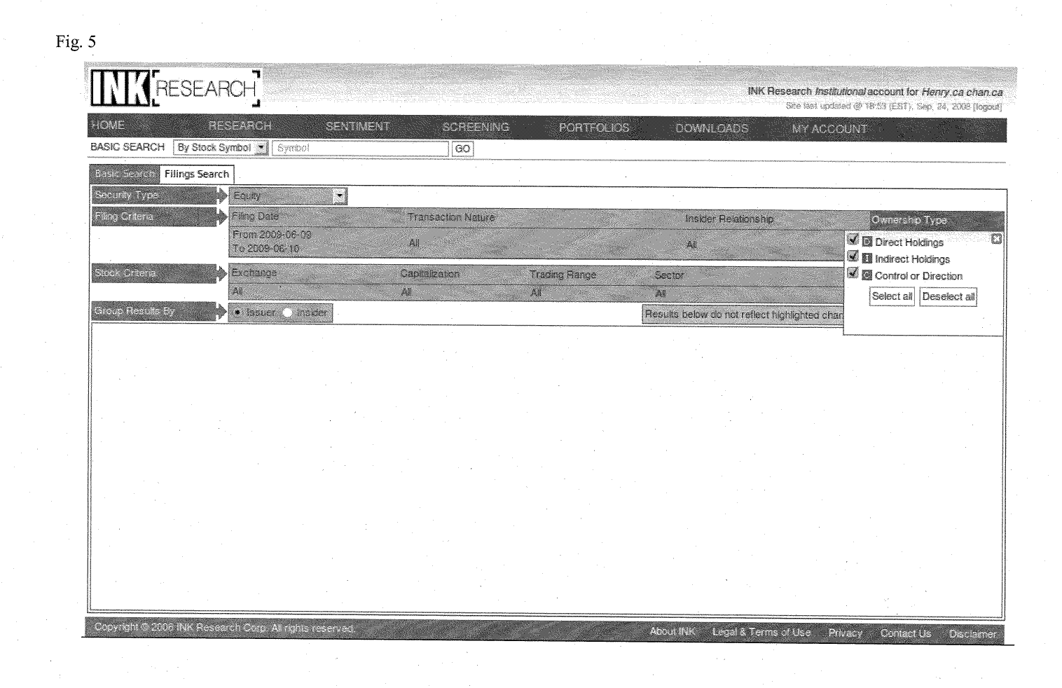

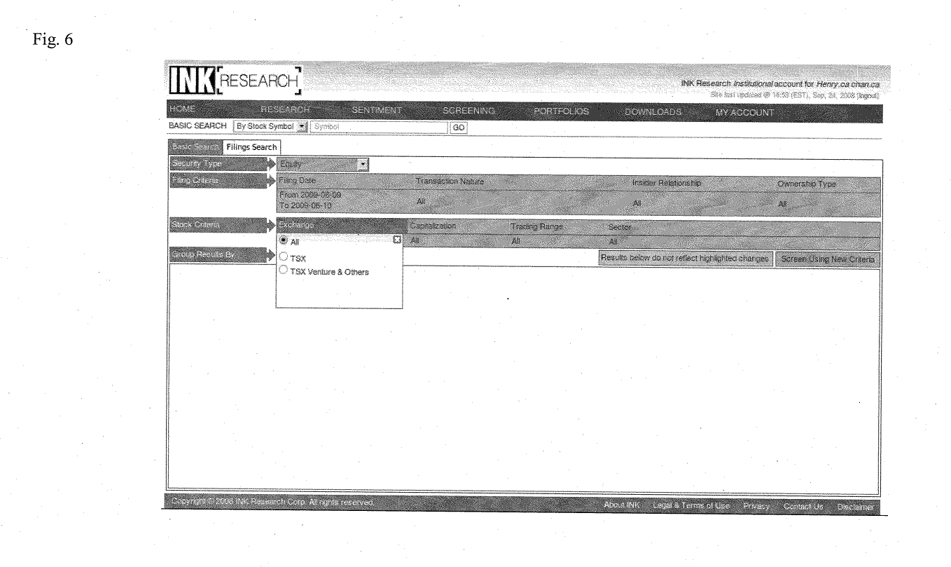

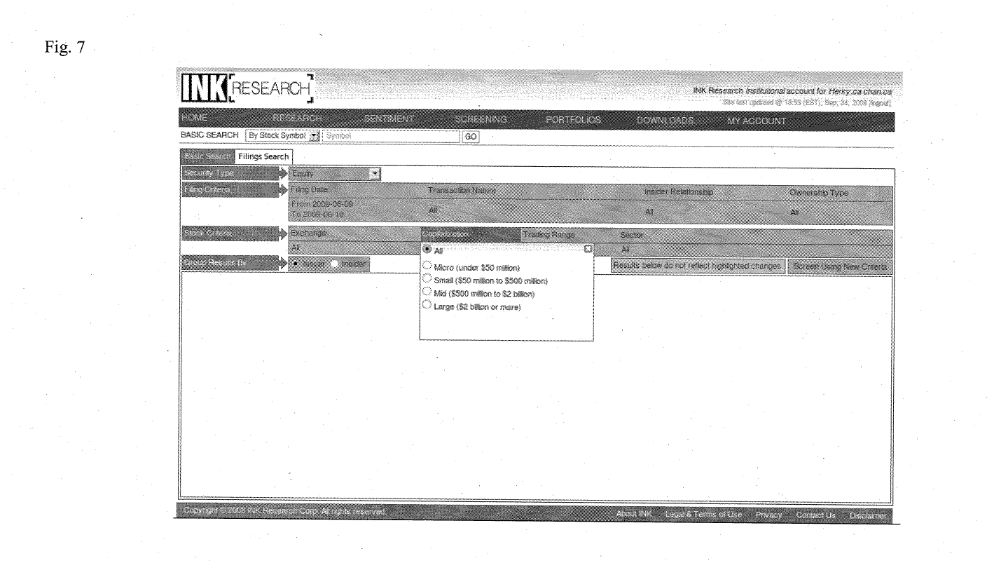

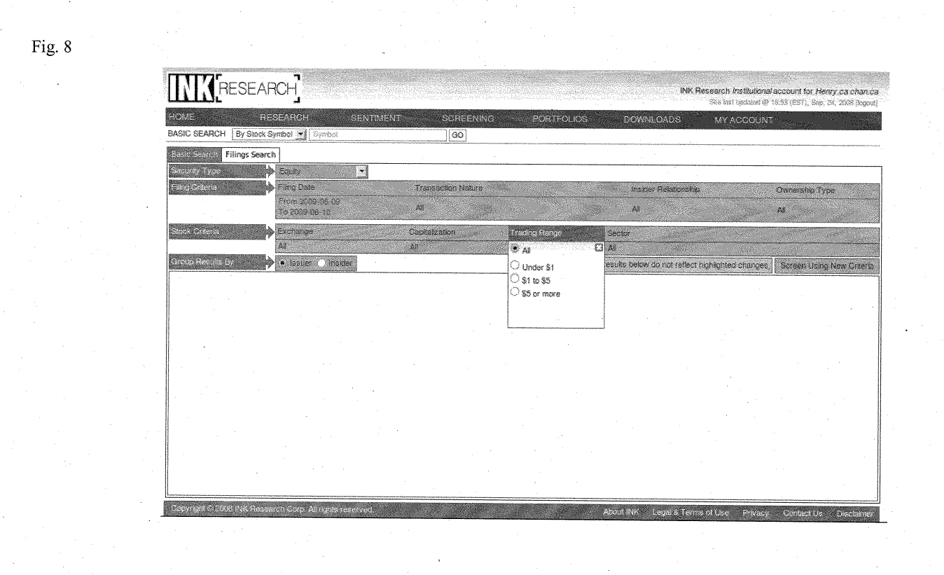

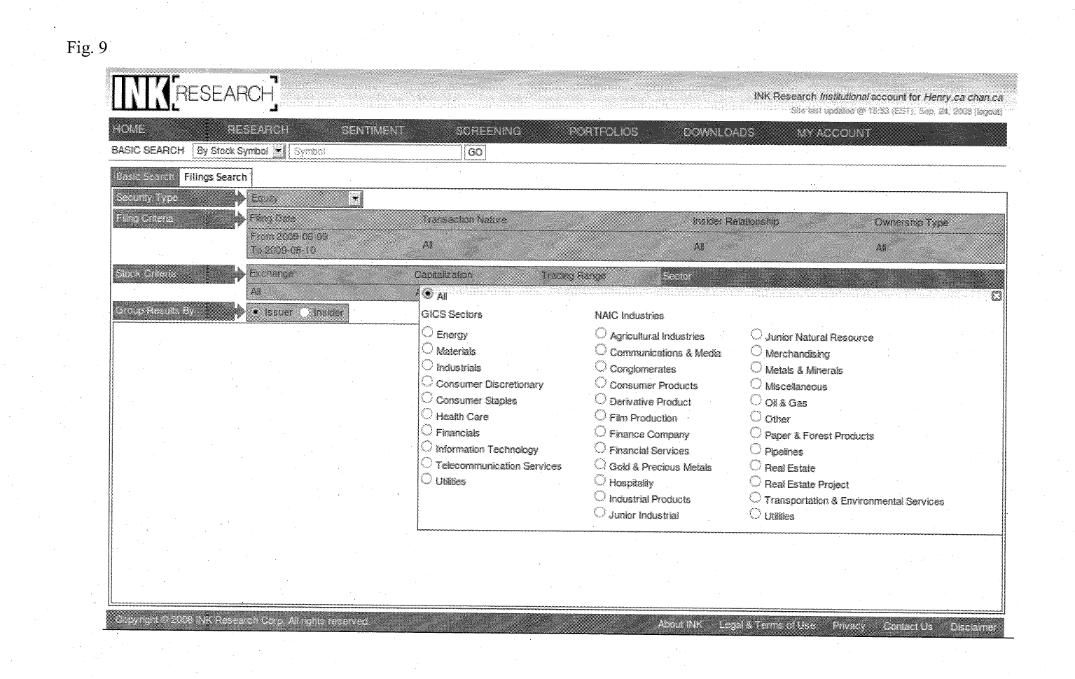

To change search/filter criteria, users would click on the header label to reveal a drop-down window with all the possible choices in the form of check boxes or radio buttons or date range selector that are available to the user, as depicted in FIGS. 2-9.

The extra space provided by the drop-down window also allows for full text description and searching/filtering instructions to be added assisting users. When a user completes selection of the desired search/filter criteria, the drop-down window can be closed by either clicking on the “X” icon on the top right-hand corner or the header label.

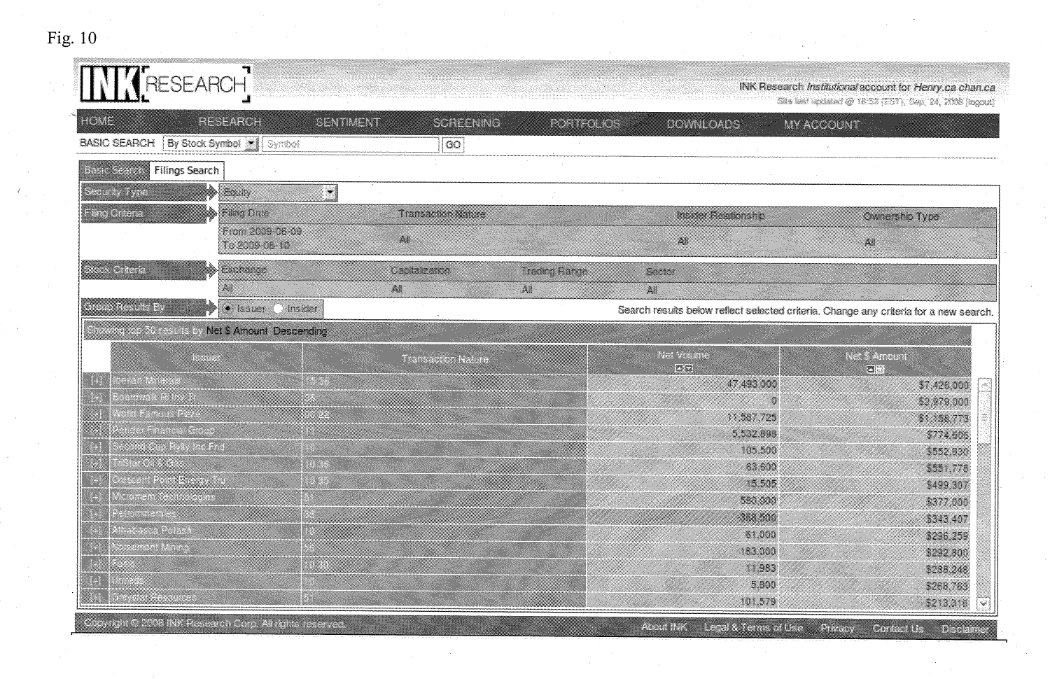

Once all the criteria is selected, the user can easily review the full set of selections and if satisfied may click on the search/filter button or in the example, the “Screen using New Criteria” button, which is also in the same bright color as the filter criteria to allow users to be warned that the filter has not yet been applied. The results are then displayed below the INK Filter Bar while all the background color of the selected criteria summary are changed to a more neutral color to indicate that all the selected criteria have been applied to the result set, as shown in FIG. 10. The “Screen using New Criteria” button also disappears from view and a message instructing users to change any of the search/filter criteria to perform a new search.

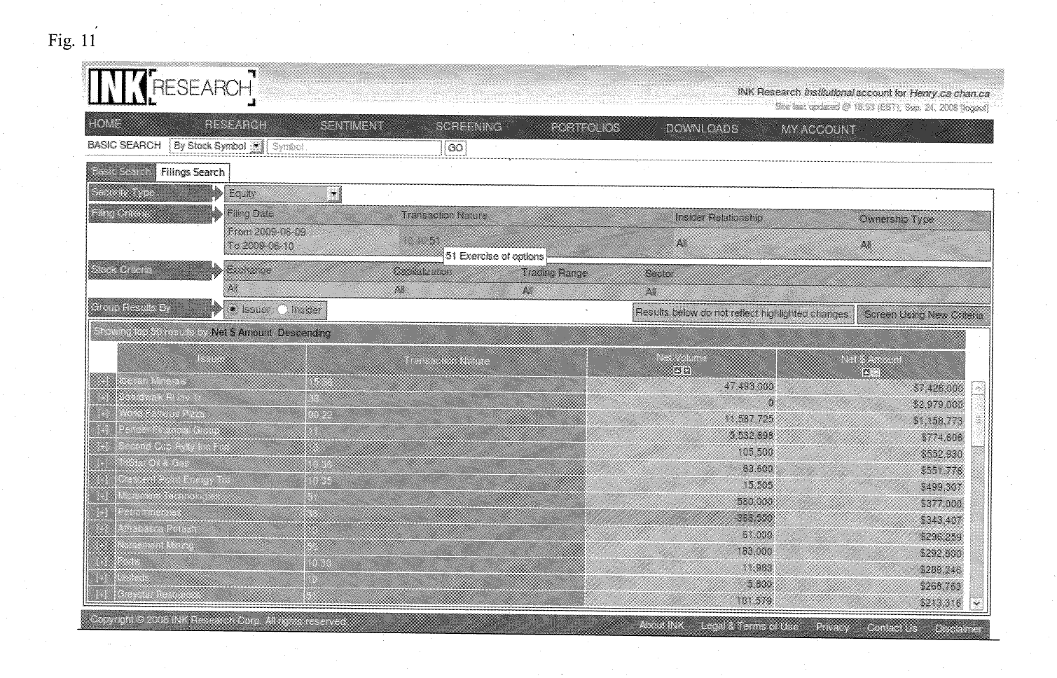

When any of the search/filter criteria are changed by the user, only that box becomes highlighted with the bright color to alert users that the particular search/filter criteria have not yet been applied to the result set, as shown in FIG. 11.

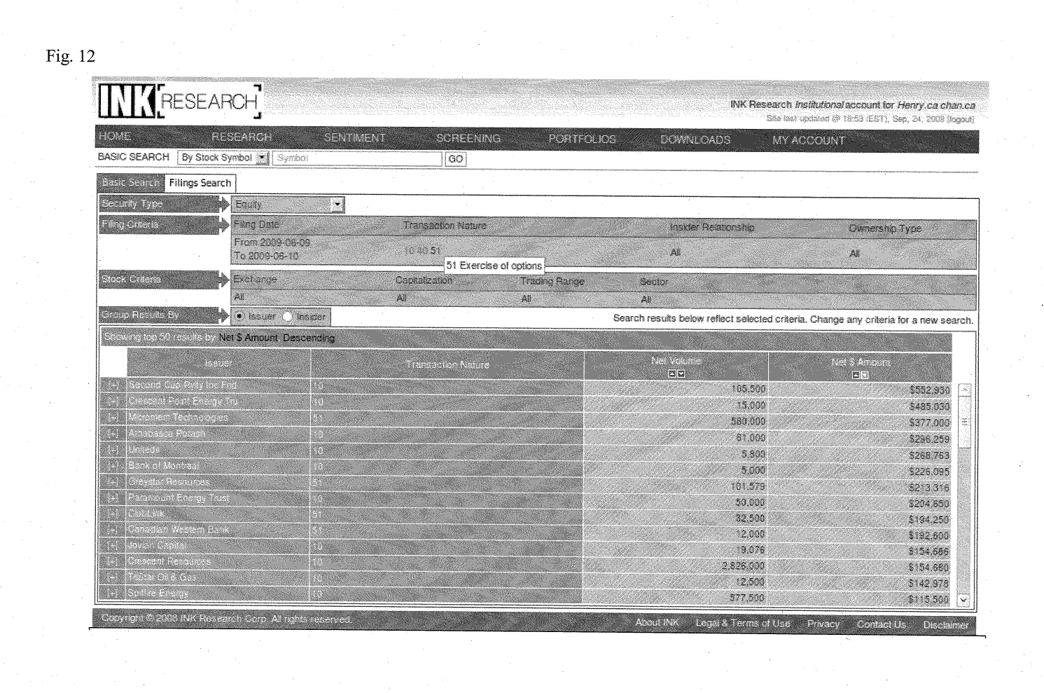

The search/filter button reappears along with the warning message that the results do not reflect all the search/filter criteria which have just been changed. Once the search/filter has been applied, the search button again disappears and the background color of all search/filter criteria summary is in the neutral color once again, as depicted in FIG. 12.

Finally, a drop-down menu (not shown) is available which allows a user to retrieve a history of the previous searches without the need to manually input those particular criteria again.

In a preferred embodiment, the invention may be used to search and filter insider trading information. Many other applications are also possible, including searching and filtering other financial data, as well as non-financial data.

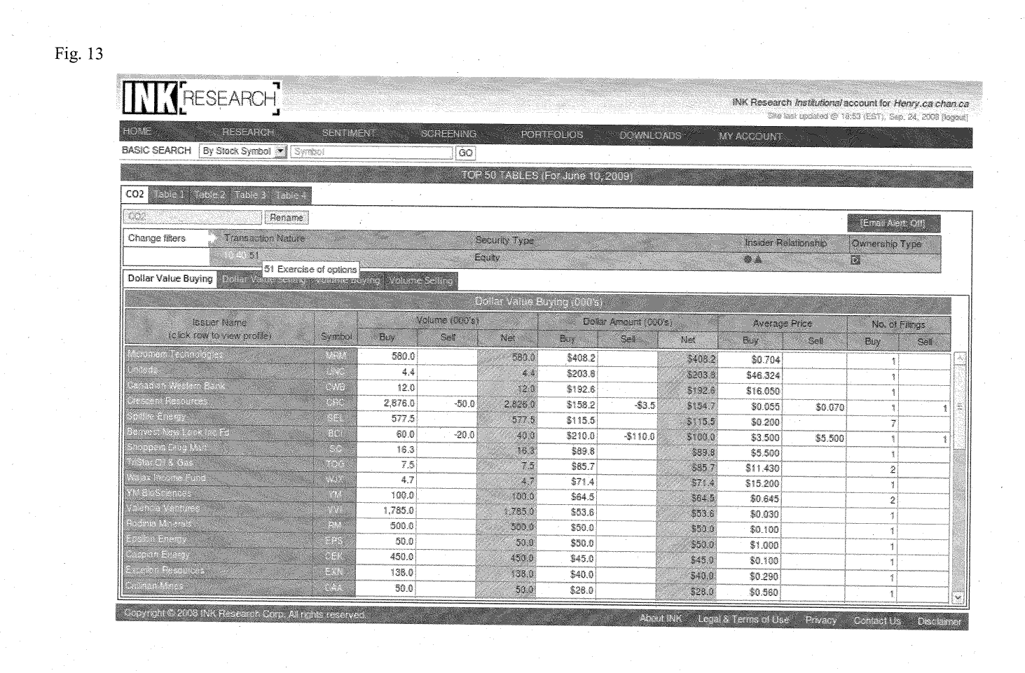

As shown in FIG. 13, the INK Filter Bar displays the currently saved setting of a user predefined filter which may be saved on the system or in a cookie and the search results showing immediately upon landing of the page or screen. As a result, the initial state of the INK Filter Bar is in a neutral color, for example, blue and no button is available to implement a new search. However, a message to the left instructs the user to change filter settings as desired.

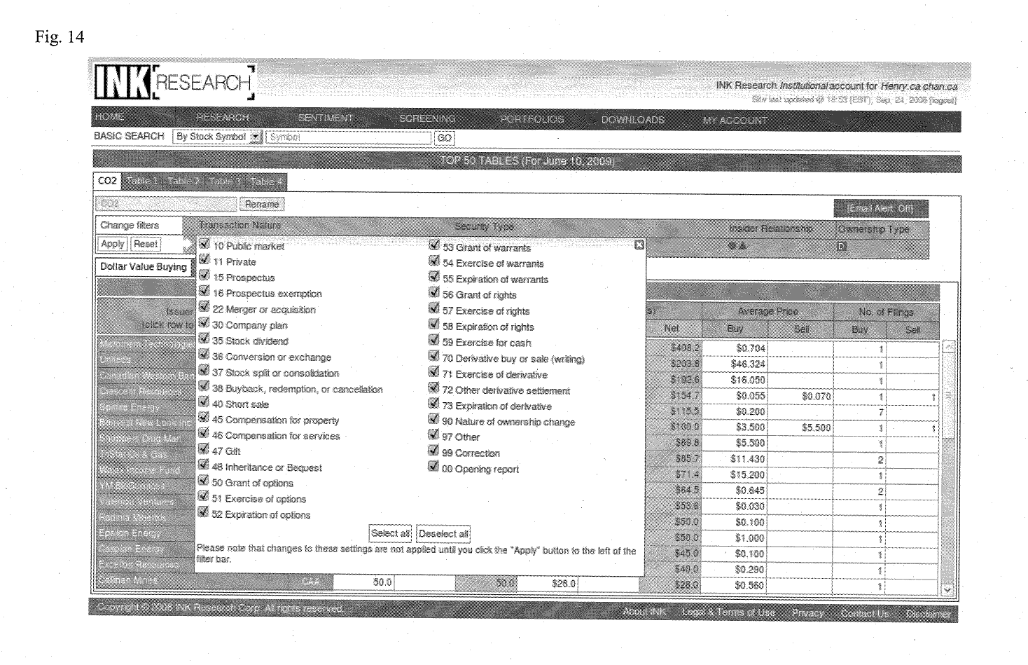

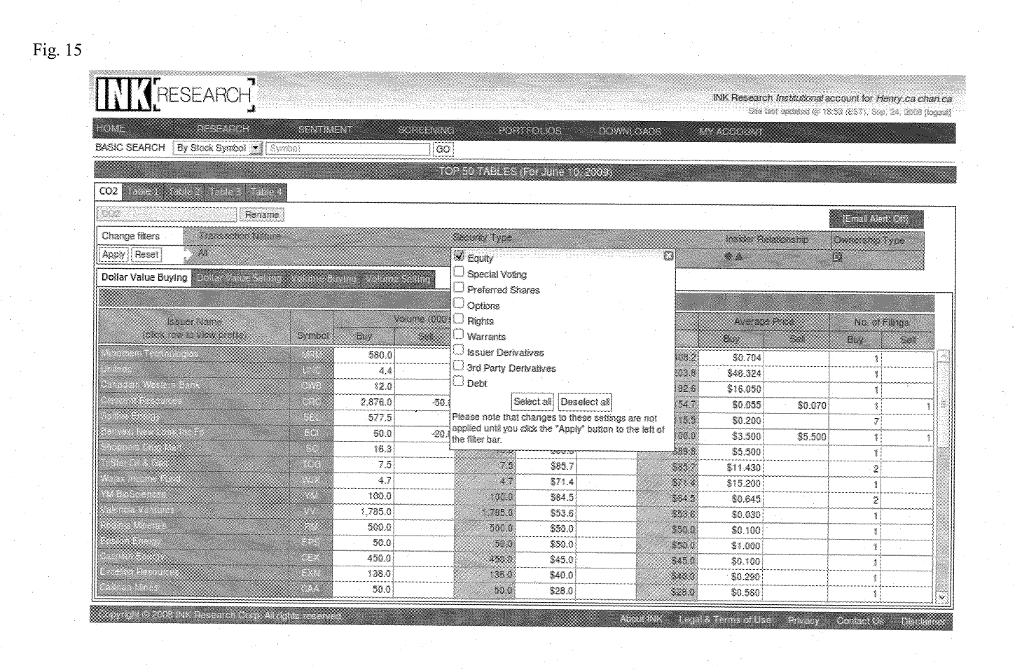

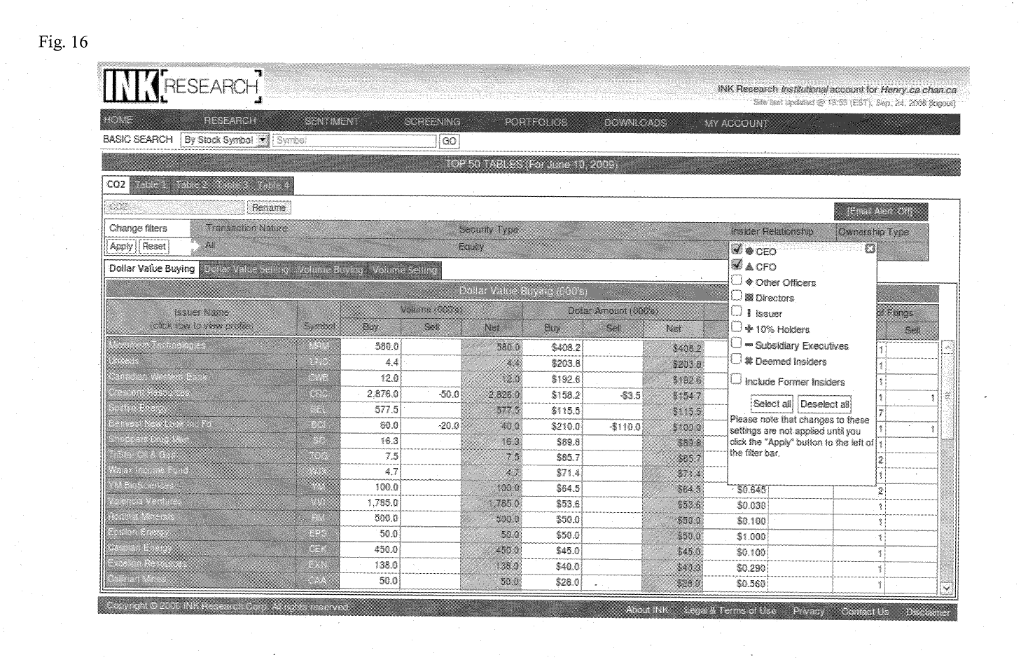

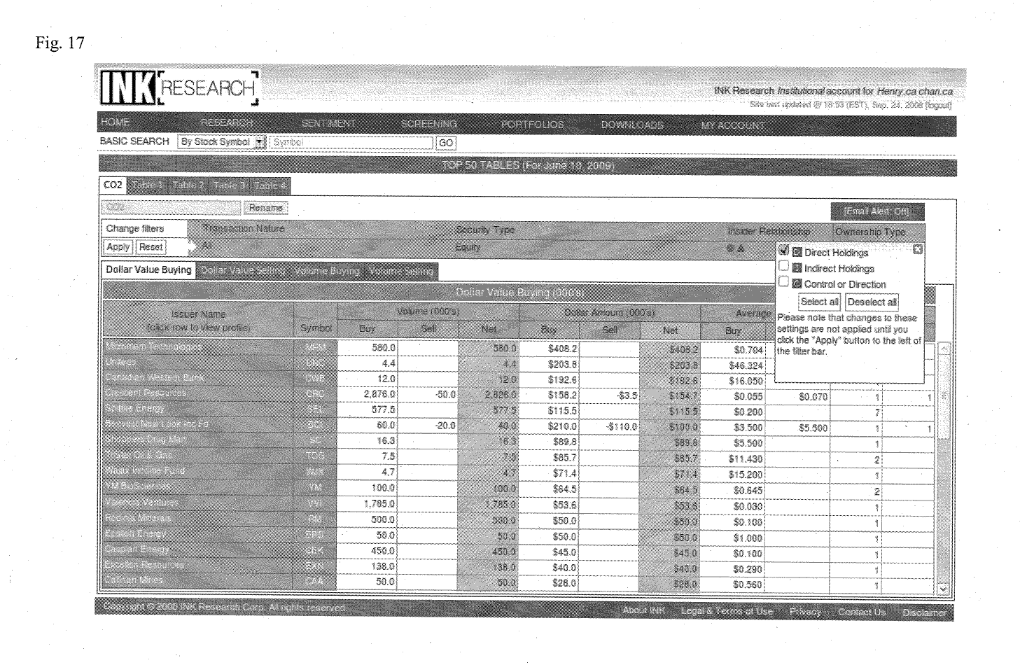

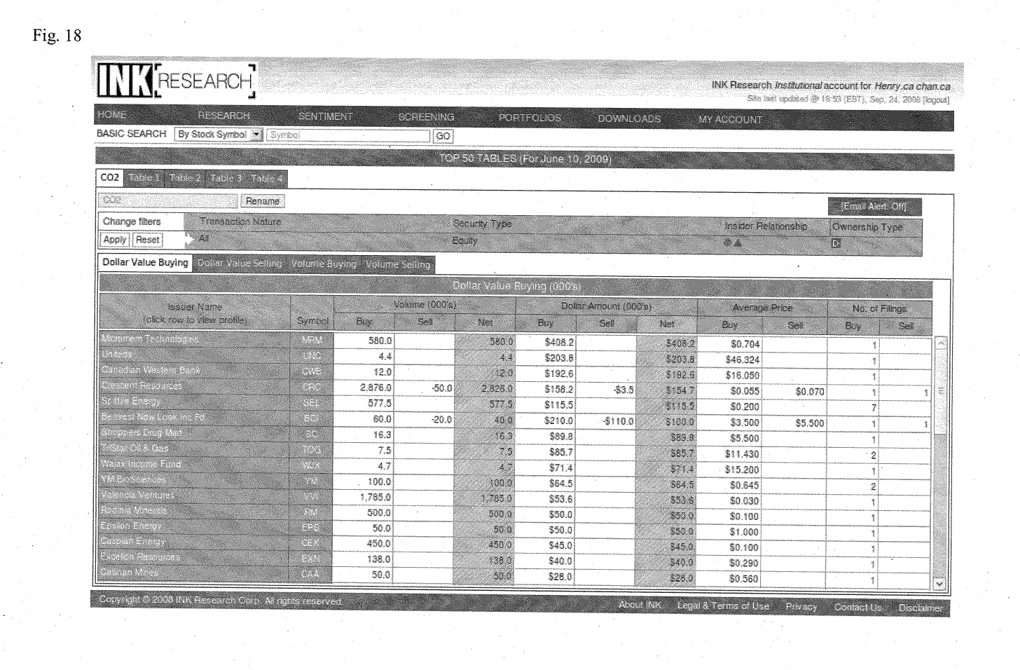

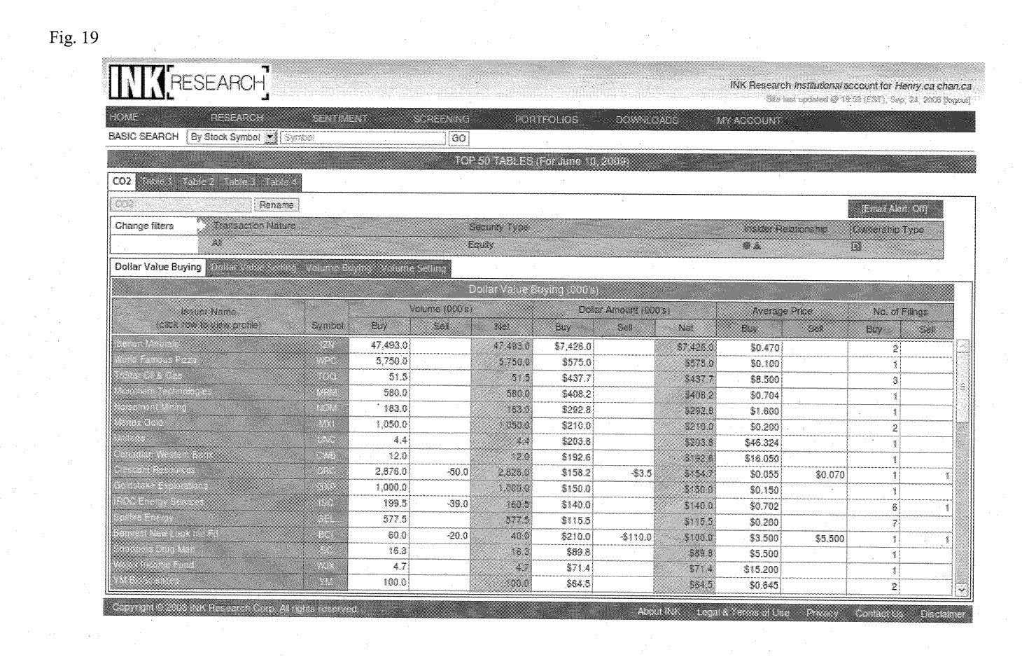

FIGS. 14-17 depict changes in the filter settings. Once any of the filter settings are changed, the background color of the INK Filter Bar changes to a bright color or to background fill that has shading or diagonal fill patterns and an apply button appears to allow the user to apply and thus save the new filter settings. FIG. 18 shows a reset button to allow the user to revert back to the previous saved filter settings. As shown in FIG. 19, once the apply button is clicked, the result set reflects the new filter criteria and the INK Filter Bar reverts back to blue.

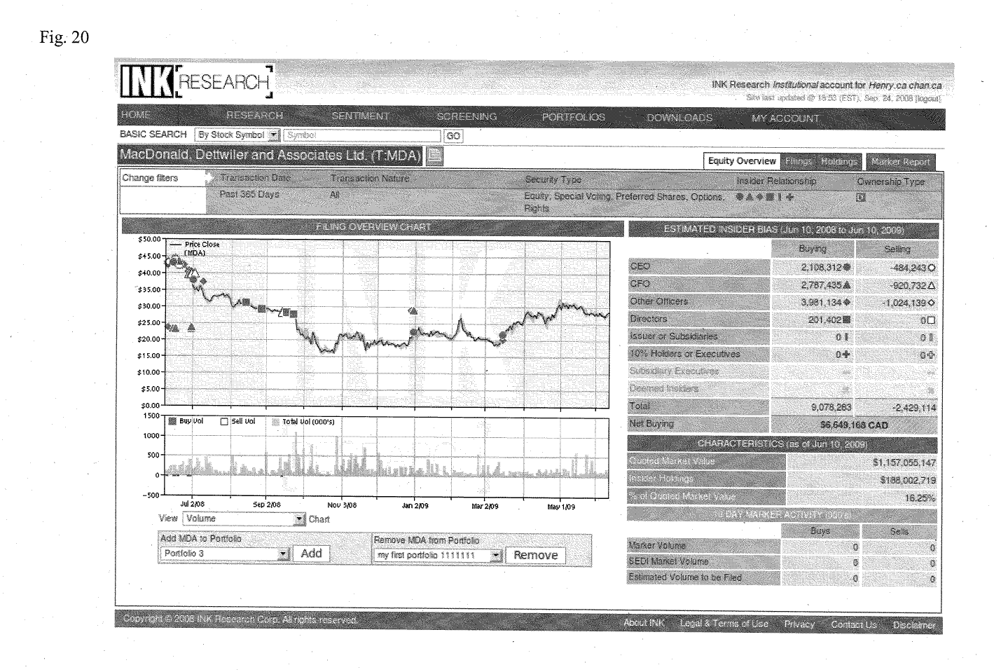

A key feature of the invention is that it can be used to summarize the criteria used to illustrate the filtered data set currently being presented either in graphical or list form. FIG. 20 depicts the data in graphical form.

The search filter settings are summarized in the INK Filter Bar in this case immediately above the resulting data and data images that have been produced by the search query. In this case, the page produces a graph of regulatory filings that meet the search criteria and are being plotted and summarized in the table beside it in the “Equity Overview” tab. A user could select other tabs such as “Filings” to view more results that meet the same search filter criteria, meanwhile the INK Filter Bar would continue to be presented, showing the relevant selected search criteria for the tab. The user can move not only across tabs, but also to different pages and the INK Filter Bar would continue to be displayed, presenting categories in the bar that are relevant to data and data images on the page or tab.

Only the search categories that are relevant to the page or tab are presented to avoid overwhelming the user with non-relevant data for that page or tab. However, this does not impact the search criteria settings for any other page or tab as the user can move back and forth across tabs and pages continually referencing the selected criteria.

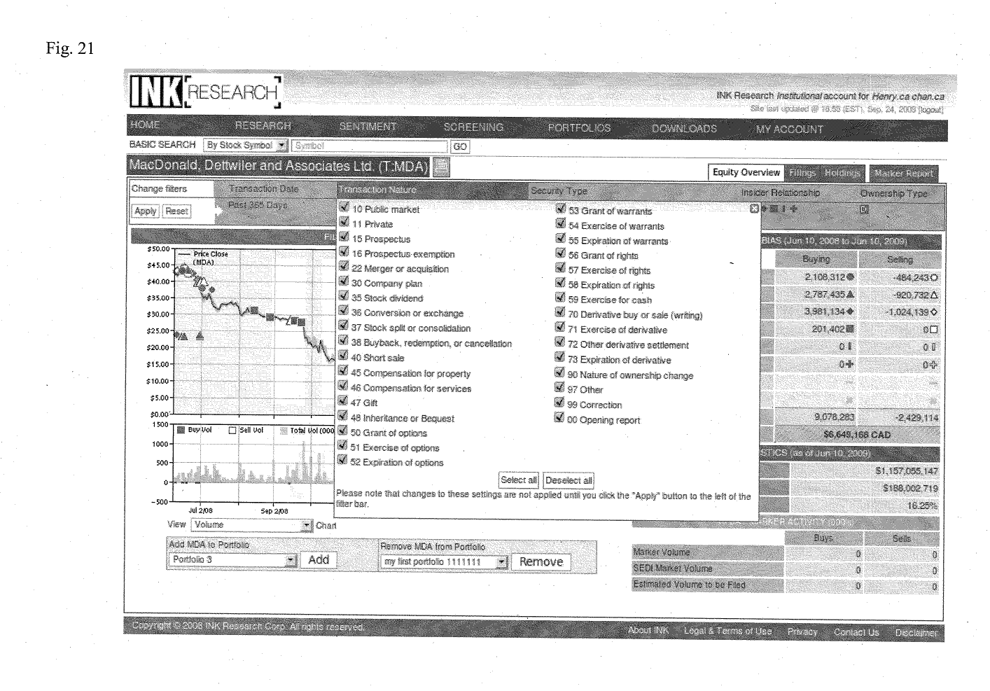

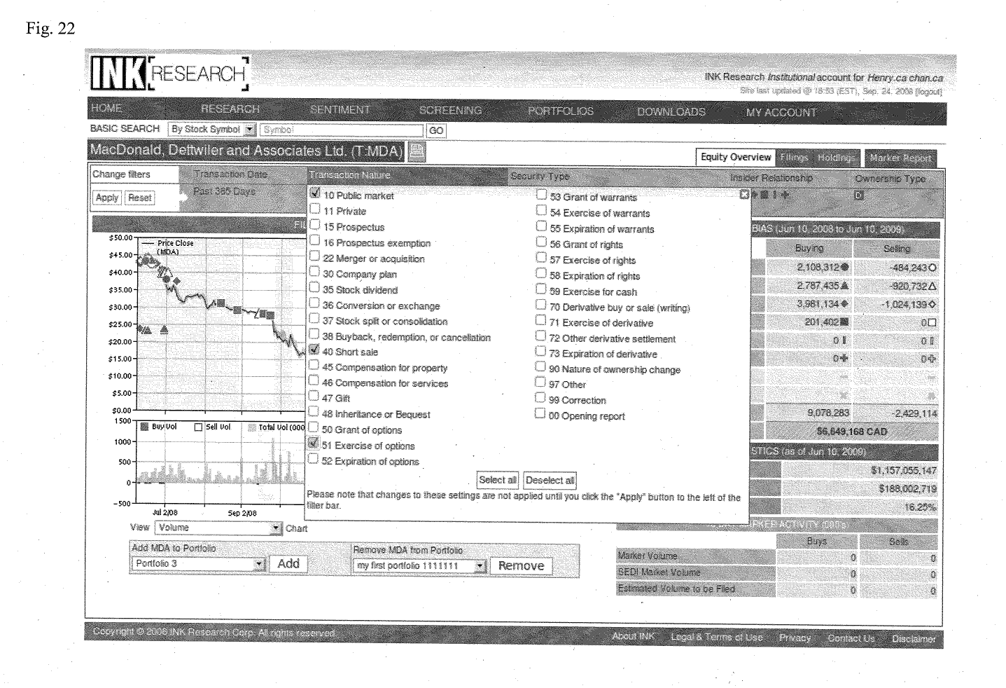

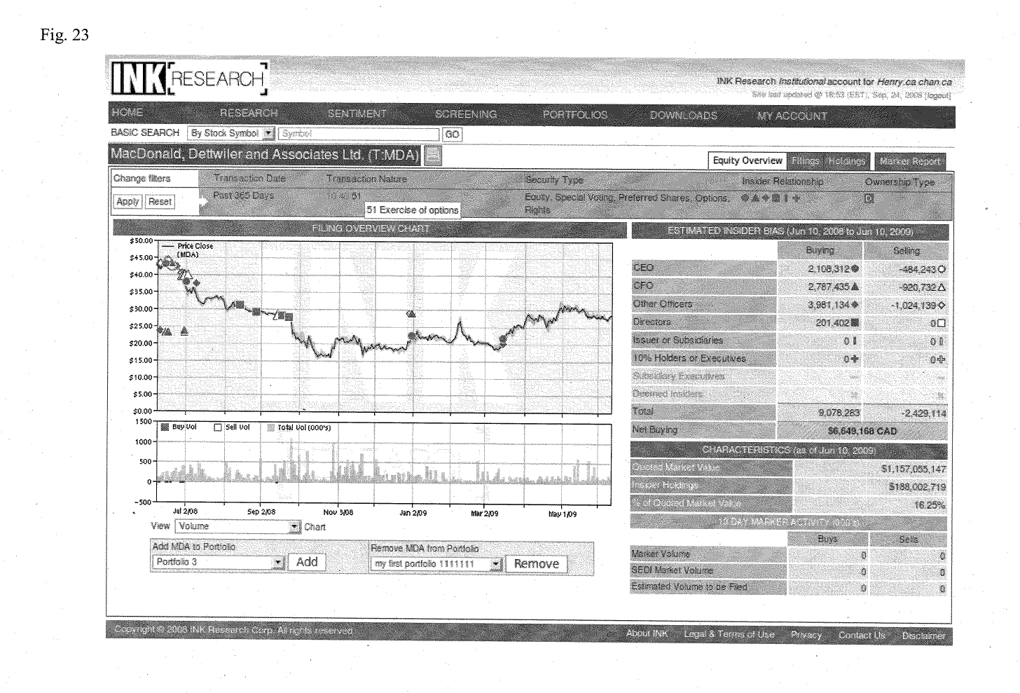

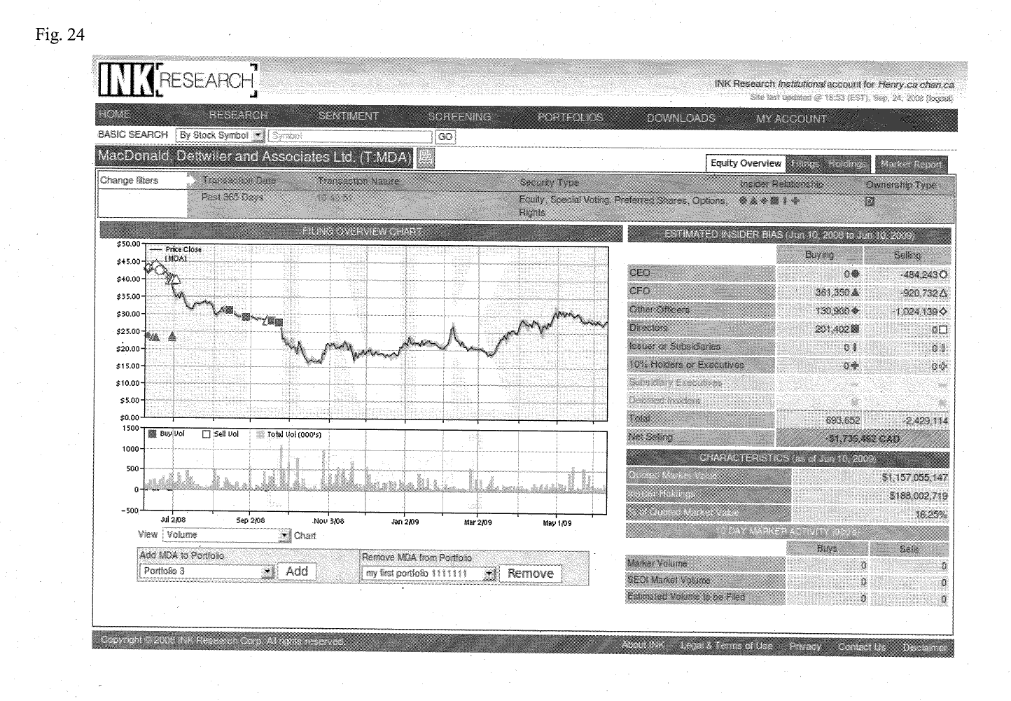

When a user wants to change the criteria, the user simply clicks on the header label to change the filter, as shown in FIGS. 21-23. After selecting a combination of criteria, the apply button is then revealed to allow the user to apply the new filter settings to the data and data images, in this case the graphs and summary table shown in FIG. 24. Once the new filter settings are applied, the INK Filter Bar returns to a more neutral color or without a patterned fill, in this back to the color blue to indicate that the current filter settings are being used to filter the data set which are graphically displayed and tabulated in the tables.

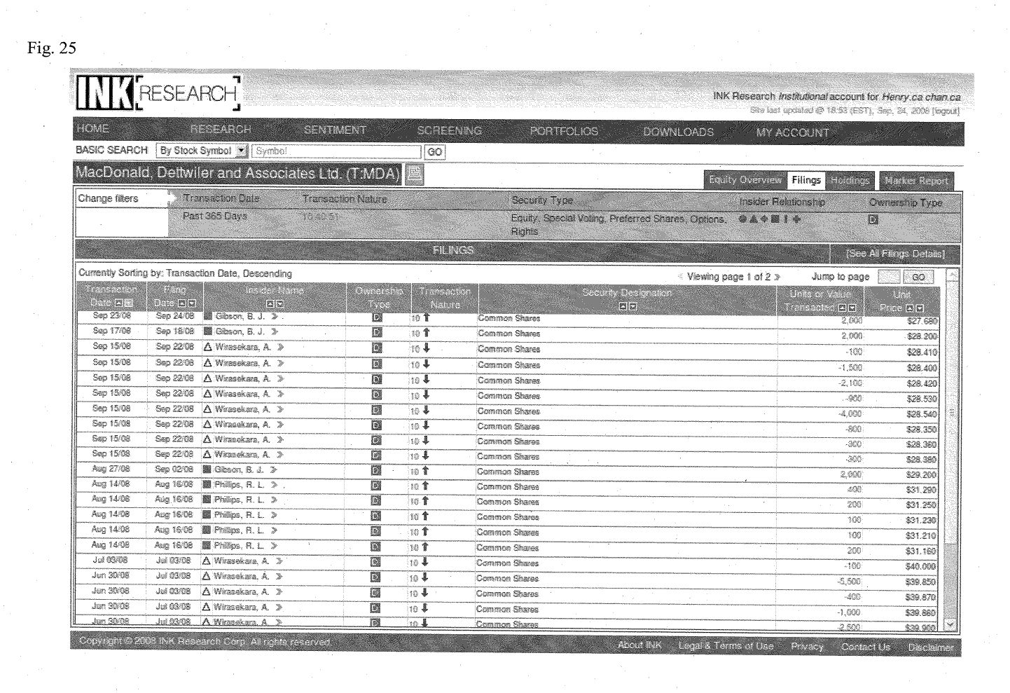

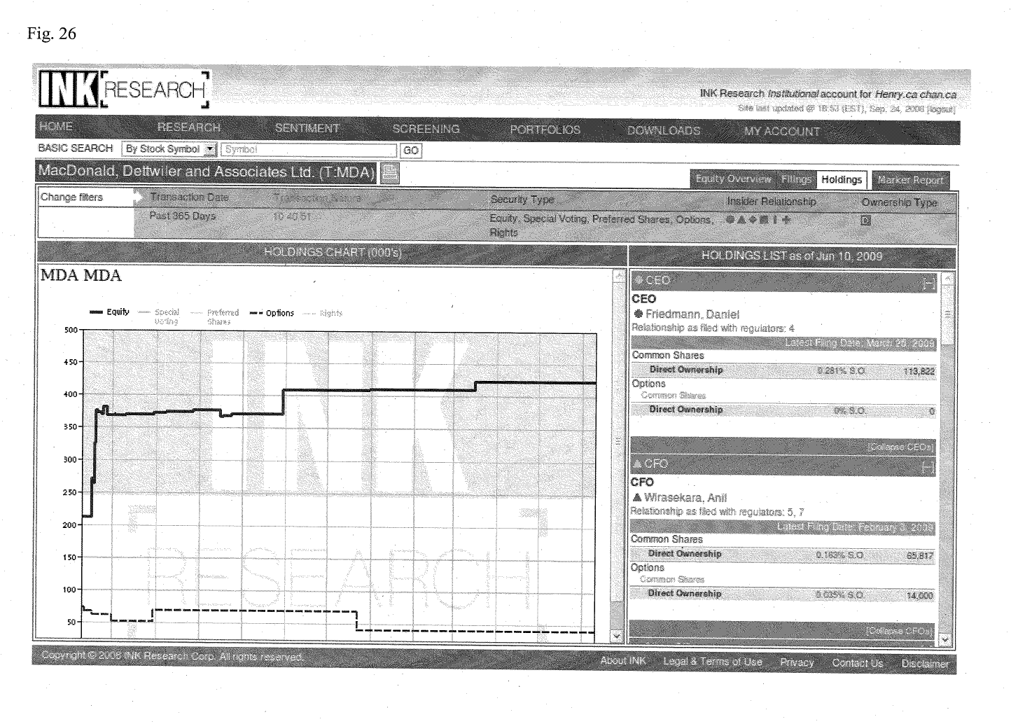

The INK Filter Bar may also be synchronized across different tabs and pages throughout the website with the searchable data, as demonstrated in FIGS. 25 and 26, which display filings and holdings results for the same filter criteria.

In operation, a user selects one or more criteria from each of several search categories. Available categories are not initially displayed, but are displayed only on demand, for example by mouse-over action to open a check list of criteria. Once all criteria are selected, the search results may be generated and displayed in a variety of formats. While continuing to view the current search results display, the user may view filter criteria in several categories by mouse-over action to display a list of criteria for a selected category. Amended filter criteria will be registered but not applied to the displayed results until the user elects to apply the criteria and generate a new result for display. Amended filter criteria may be further amended, or all amended criteria may be cancelled prior to the user electing to apply the amended criteria to the search results.

The use of icons allows the user not only to reference them from the INK Filter Bar settings to the data and data-images presented in conjunction with the INK Filter Bar, but also allows the user to mouse-over the icons for information about the data point in question, or to click on the icon to be provided more information about that data point, either by taking the user to another tab or page, or providing a new window or pop up with the relevant information. This click-through function can be undertaken directly in the INK Filter Bar.

Although not shown, the INK Filter Bar may be set to apply changes instantaneously once the drop-down window is closed. Under this setting, the change of color to indicate the criteria hasn't been applied would not be necessary and neither would the search/apply button normally displayed once new criteria have been inputted.

Finally, the INK Filter Bar is detachable from the web page to permit users to refer to it as the user visits other websites. The user can change the search criteria even though the user may not be viewing a web page with data and data images of the selected search. The detached bar will continue to display the search categories that were displayed immediately before being detached.

The INK Filter Bar provides multiple category search criteria and filter mechanisms that are continuously displayed along with the search-generated data and data images. It utilizes an icon system utilizing symbols, numbers, letters, icons and mini scroll bars and is used in conjunction with mouse-over technology to economize space to allow the continuous display of complex and multi-category search criteria. These icons may also be used within the search-generated data and data images to promote easy reference between the search criteria and search results.

The INK Filter Bar with its search criteria and summarized filter mechanisms remain accessible and may be displayed across different pages and tabs of data. Search criteria may be altered at any time directly from the page or tab displaying the filtered data and this can be done without reverting back to a search page. Default and previous search criteria can be restored without having to revert to a previous page.

It will be appreciated by those skilled in the art that other variations of the preferred embodiment may also be practiced without departing from the scope of the invention.

We claim:

1. A computer-implemented method for providing a user with database search results in response to search categories and filter criteria selected by the user, comprising the following steps:
a) selection by the user of a search category to display;
b) selection by the user of one or more filter criteria from the list of displayed filter criteria within the displayed search category;
c) repetition of steps a) and b) until all desired filter criteria have been selected;
d) search of the database by applying the selected filter criteria to produce a database search result; and
e) selection by the user of a display mode for the database search result.

2. The method of claim 1, further comprising the additional step after step e) of:
f) repetition of steps a) through e) until a desired search result is displayed in a desired display mode.

3. The method of claim 2, wherein the user may identify the filter criteria within a search category prior to selection of that search category by moving a cursor or similar computer selection tool over a computer icon representing that search category.

4. The method of claim 2, wherein selection of a filter criterion effects a change in an indicator means to allow visual distinction between selected filter criteria and unselected filter criteria prior to application of the criteria to a database search.

5. The method of claim 4, wherein application of a filter criterion to a database search effects a change in an indicator means to allow visual distinction between unapplied filter criteria and applied filter criteria.

6. The method of claim 4 wherein the indicator means comprises a change in colours, shades, or background patterns.

7. The method of claim 4 wherein the indicator means comprises a change in text fonts or text styles.

8. The method of claim 5 wherein the indicator means comprises a change in colours, shades, or background patterns.

9. The method of claim 5 wherein the indicator means comprises a change in text fonts or text styles.

10. A computer program for instructing a computer to perform the method of claim 2.

11. A computer program for instructing a computer to perform the method of claim 6.

12. A computer program for instructing a computer to perform the method of claim 8.

13. A computer readable memory having recorded thereon statements and instructions for execution by a computer to carry out the method of claim 2.

14. A computer readable memory having recorded thereon statements and instructions for execution by a computer to carry out the method of claim 6.

15. A computer readable memory having recorded thereon statements and instructions for execution by a computer to carry out the method of claim 8.

16. A networked computer system comprising a server, wherein the server is configured to define a plurality of graphical user interfaces on an access device associated with a user, the interfaces comprising: a plurality of user-selectable parameters, including at least one filter criterion selected from a plurality of available filter criteria and at least one result control for controlling display of search results determined for the selected filter criteria.

17. The networked computer system of claim 16, wherein a user may identify the filter criteria within a search category prior to selection of that search category by moving a cursor or similar computer selection tool over a computer icon representing that search category.

18. The networked computer system of claim 16, wherein selection of a filter criterion effects a change in an indicator means to allow visual distinction between unapplied filter criteria and applied filter criteria.

19. The networked computer system of claim 18, wherein the indicator means comprises a change in colours, shades, or background patterns.

20. The networked computer system of claim 18, wherein the indicator means comprises a change in text fonts or text styles.
